(19) United States
(12) Patent Application Publication
(10) Pub. No.: US 2025/0361124 A1
(43) Pub. Date: Nov. 27, 2025

(54) UNIT FOR OFFSHORE APPLICATION, COMPRISING A DECK EQUIPPED WITH AN ARTICULATED BOOM CRANE

(71) Applicant: REEL, SAINT-CYR-AU-MONT-D'OR (FR)

(72) Inventors: Frank HEEN, BLOMSTERDALEN (NO); Bart BURGER, NIEUW-VENNEP (NL)

(21) Appl. No.: 19/192,831

(22) Filed: Apr. 29, 2025

(30) Foreign Application Priority Data
May 24, 2024 (FR) 2405343

(51) Int. Cl. B66C 23/88; B63B 27/10; B66C 23/52

(52) U.S. Cl. CPC B66C 23/88; B63B 27/10; B66C 23/52; B66C 2700/0392

(57) ABSTRACT

The present invention relates to a unit (1) for offshore application, comprising a deck (2) equipped with a crane (3) with an articulated boom (4).
which crane (3) comprises:
a support structure (5), secured to said deck (2), and
an articulated boom (4), carried by said support structure (5).

The articulated boom (4) comprises a main boom (41) and a terminal boom (42), in series, which terminal boom (42) has a head (422) at the opposite side of said support structure (5).

This deck (2) is equipped with a cradle (10), at a distance from the support structure (5), which comprises a receiving portion (101) on which a head (422) of said terminal boom (42) is intended to rest in said rest position.

### TECHNICAL FIELD OF THE INVENTION

The present invention relates to the technical field of offshore application units, comprising a deck equipped with an articulated boom crane.

### STATE OF THE ART

Some offshore unit, particularly ships, have a deck equipped with an articulated boom crane.

Such cranes include:
a support structure, secured to the deck, and
an articulated boom, carried by said support structure,
operating means for operating said articulated boom between a working position (deployed) and a rest position (folded), and
control means for piloting said operating means.

In addition, the articulated boom includes a main boom and a terminal boom, in series.

Typically, these cranes spend most of their time in a resting position.

They can then withstand the stresses that can occur during a storm, when the movements of the unit and the wind induce forces on the crane.

To contribute to this resistance, the units often include a solution to support the boom maneuvered in this rest position.

A traditional solution involves the use of a boom support, commonly called a “boom rest” which is erected from the deck and which is arranged to rest under the main boom (advantageously horizontally).

This boom support is then relatively long, approximately the length of the support structure.

However, this approach has significant drawbacks.

The boom support, in addition to consuming valuable space on the deck of the unit, constitutes a relatively heavy construction.

In fact, the dead weight of this boom support, combined with the loads applied by the articulated boom in the rest position, requires additional reinforcement of the unit deck.

This structural overload, and the need for dedicated space for the boom support, represent significant constraints in the design of cranes for units, limiting operational efficiency and flexibility of use.

Thus, there is a clear need for a more efficient and economical solution to ensure the stability of unit cranes, in the rest position.

### PRESENTATION OF THE INVENTION

In order to overcome the aforementioned drawback of the state of the art, the present invention proposes a unit for offshore application, comprising a deck equipped with an articulated boom crane.

The crane includes:
a support structure, secured to said deck, and
an articulated boom, carried by said support structure,
operating means for operating said articulated boom between a working position and a rest position, and
control means for piloting said operating means.

The articulated boom comprises a main boom and a terminal boom, in series, which terminal boom has a head at the opposite side of said support structure.

And, according to the invention, said deck is equipped with a cradle, at a distance from the support structure, which comprises a receiving portion on which the head of said terminal boom is intended to rest in said resting position.

Such a technical solution has various advantages over the prior art:
it frees up valuable deck space, as such a cradle is significantly less bulky compared to the traditional solution;
it significantly eliminates the dead weight of the cradle;
it reduces the need for reinforcements under the deck, because the interface loads are lower.

Other non-limiting and advantageous characteristics of the product according to the invention, taken individually or in all technically possible combinations, are as follows:
the deck is equipped with said cradle and is devoid of an additional support for the main boom;
the cradle is installed on the deck so that, in the rest position, the terminal boom has an angle ranging from 0 to 10° relative to the vertical;
the cradle consists of a column, erected on the deck, which includes:
a lower end secured to the deck, and
an upper end comprising the receiving portion;
the head of the terminal boom and the receiving portion comprise complementary surfaces, for example cylindrical complementary surfaces, adapted to cooperate by interlocking;
the head of the terminal boom comprises two support members, on either side of said head, and the receiving portion comprises two receiving strips which are intended to come on either side of said head and to each receive one of said support members; each receiving strip advantageously comprises at least one inclined flap (possibly two inclined flaps, in a V shape) which ends, at a lower end, with a notch intended to receive said support member; said at least one inclined flap advantageously comprises a coating adapted to limit friction;
the crane has locking means for locking the crane in its rest position.

The present invention also relates to a method of maneuvering the crane on a unit according to the invention, between said working position and said rest position.

When manoeuvring from the working position to the rest position, the crane is manoeuvred so that the head of the terminal boom is manoeuvred towards the cradle until it rests on the receiving portion.

Preferably, in the rest position, the terminal boom has an angle ranging from 0 to 10° relative to the vertical.

Of course, the various features, variants and embodiments of the invention may be combined with each other in various combinations to the extent that they are not incompatible or mutually exclusive.

### DETAILED DESCRIPTION OF THE INVENTION

In addition, various other characteristics of the invention emerge from the appended description given with reference to the drawings which illustrate non-limiting embodiments of the invention and where:

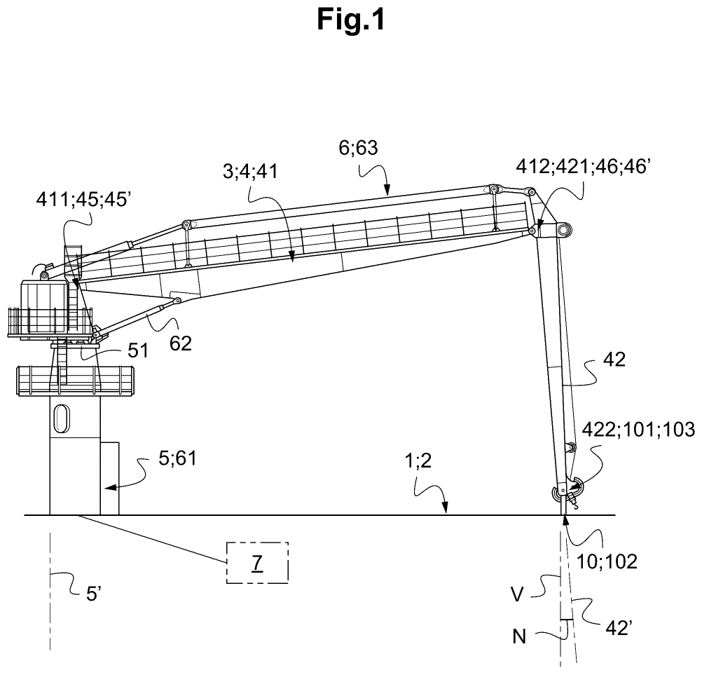

FIG. 1 is a schematic view, seen from the side, illustrating a unit for offshore application, comprising a deck equipped with an articulated boom crane and a cradle adapted to receive the head of the articulated boom in the rest position;

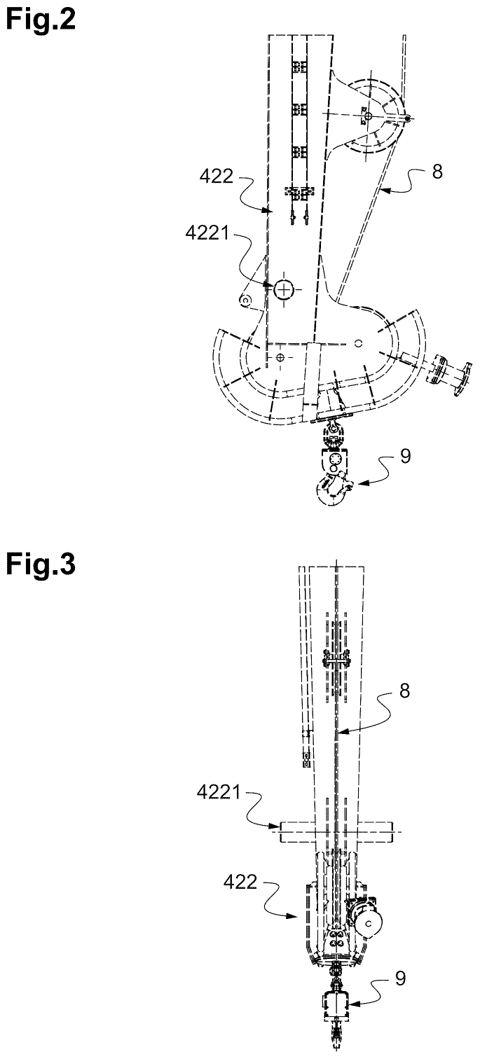

FIG. 2 is a partial and enlarged view of FIG. 1, illustrating in more detail the head of the articulated boom, seen from the side;

FIG. 3 is a partial and enlarged view of FIG. 1, illustrating in more detail the head of the articulated boom, seen from the front;

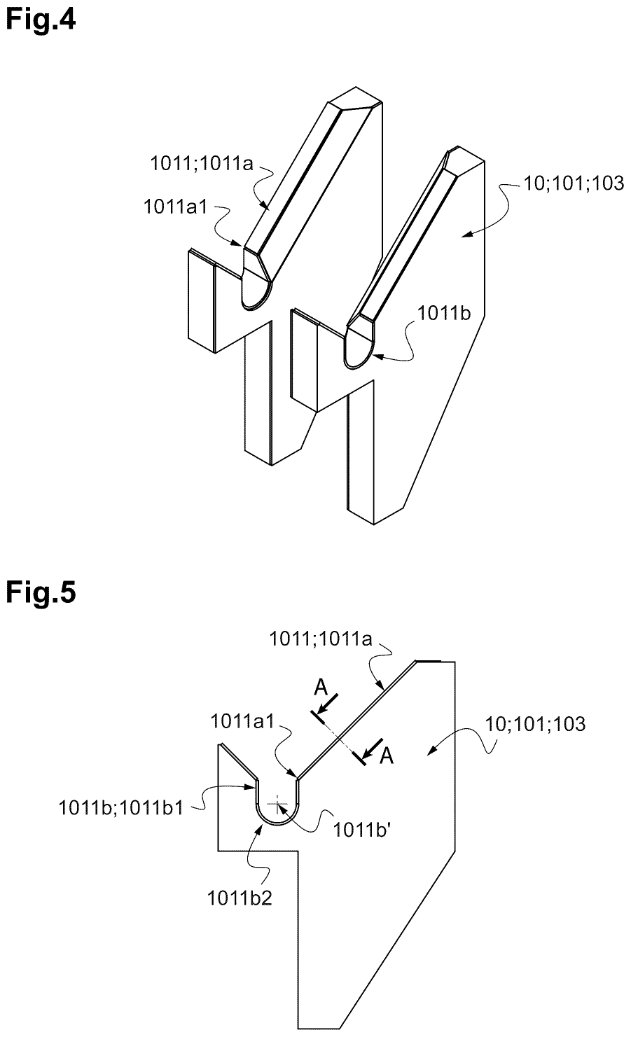

FIG. 4 is a partial and enlarged view of FIG. 1, illustrating in more detail the cradle, seen in perspective;

FIG. 5 is a partial and enlarged view of FIG. 1, illustrating in more detail the cradle, seen from the side;

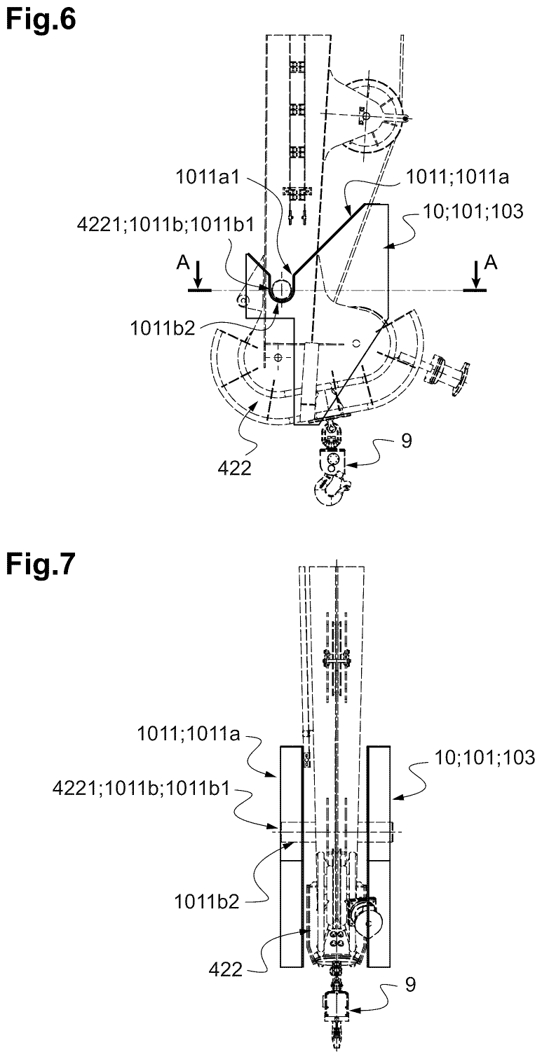

FIG. 6 is a partial and enlarged view of FIG. 1, illustrating in more detail the cooperation between the head of the articulated boom and the cradle, seen from the side;

FIG. 7 is a partial and enlarged view of FIG. 1, illustrating in more detail the cooperation between the head of the articulated boom and the cradle, seen from the front.

It should be noted that, in these figures, the structural and/or functional elements common to the different variants may have the same references.

The present invention relates to a unit 1 for offshore application (shown very partially in FIG. 1), comprising a deck 2 equipped with a crane 3 with an articulated boom 4.

Crane 3 is thus adapted to be embarked on the “offshore” unit 1, for example a vessel for operation service (also called “Service Operation Vessel”).

By “unit” we mean in particular marine units, in particular ships, for example a ship for operation service in a wind farm (also called “wind Farm Service Operation Vessel » or « wind farm SOV » in English).

Such a crane 3 is thus useful, without being limiting, for the maneuvering of tools and spare parts for intervention on offshore wind turbines.

As subsequently developed, the articulated boom 4 is intended to be maneuvered between a working position and a rest position.

And, according to the invention developed subsequently, the deck 2 is equipped with a cradle 10, advantageously forming a boom support, on which the articulated boom 4 is intended to rest in the rest position.

### Crane

The crane 3 with articulated boom 4, also called a “crane” or “knuckle boom crane” in English, is suitable for offshore applications.

Such a crane 3 with an articulated boom 4 is for example described, without being limiting, in the document FR3117099.

As schematically illustrated in FIG. 1, the crane 3 with articulated boom 4 comprises:
a support structure 5 (also called “crane house”), forming the interface between crane 3 and unit 1,
the articulated boom 4 (also called “knuckle boom”), carried by the support structure 5,
operating means 6, for operating the articulated boom 4 and in particular its downstream end described below, and
control means 7, for piloting these operating means 6.

The support structure 5 advantageously consists of a barrel or mast. This support structure 5 is secured to the deck 2.

Preferably, this support structure 5 comprises articulation means 51 (also called “slewing mechanism”), for example a slewing ring with ball bearing, to define a pivoting movement of the articulated boom 4 along a pivot axis 5′ (also called “slewing”).

This pivot axis 5′ thus gives a degree of freedom in rotation to the articulated boom 4, advantageously perpendicular to the deck 2.

The articulated boom 4 comprises two boom parts 41, 42 (also called arms or sections), assembled in series from the support structure 5:
a main boom 41 (also called “main boom”), upstream or proximal, and
a terminal boom 42 (also called a “jib”), downstream or distal.

The main boom 41 and the terminal boom 42 each comprise:
an upstream end 411, 421, located on the side of the support structure 5, and
a downstream end 412, 422, located at a distance from the support structure 5.

The support structure 5 and the upstream end 411 of the main boom 41 cooperate by means of upstream articulation means 45 to define an oscillation movement of said main boom 41 along an upstream articulation axis 45′ (also called “luffing” or lifting movement), advantageously horizontal and perpendicular to the pivot axis 5′.

Thus, the main boom 41 is intended to be maneuvered in rotation relative to the support structure 5, around this upstream articulation axis 45′ located at its upstream end 411.

The downstream end 412 of the main boom 41 and the upstream end 421 of the terminal boom 42 cooperate by means of downstream articulation means 46 to define a folding movement of said terminal boom 42 along a downstream articulation axis 46′ (called “folding” axis), advantageously horizontal and perpendicular to the pivot axis 5′.

Thus, the terminal boom 42 is intended to be maneuvered in rotation relative to the main boom 41, around the downstream articulation axis 46′ located at its upstream end 421.

The upstream articulation means 45 and the downstream articulation means 46 advantageously consist of articulations, for example in the form of rolling bearings, which are arranged between the assembled ends (for example of the bearing/pin type).

The upstream articulation axis 45′ and the downstream articulation axis 46′ extend parallel to each other, advantageously horizontally.

And the terminal boom 42 has a head opposite the support structure 5, corresponding here to the downstream end 422 of the terminal boom 42 (FIGS. 2 and 3).

Preferably, the head 422 (designated by the same reference as the downstream end 422 of the terminal boom 42, for the sake of simplicity) also refers to the downstream end 422 of the articulated boom 4 from which at least one cable 8 and at least one fixing interface 9 (for example a hook or another device for fixing a load) extend.

According to a preferred embodiment, the head 422 of the terminal boom 42 comprises at least one support member 4221 which is intended to cooperate with a complementary surface of the aforementioned cradle 10.

The head 422 of the terminal boom 42 and the cradle 10 thus advantageously comprise complementary surfaces, for example cylindrical complementary surfaces, adapted to cooperate by interlocking.

In this sense, the at least one support member 4221 advantageously consists of a cylindrical support member (advantageously projecting laterally).

More preferably, this head 422 comprises two support members 4221, arranged on either side of the head 422.

These support members 4221 advantageously extend coaxially and perpendicularly with respect to a general plane of the head 422.

In other words, the support members 4221 extend parallel to the upstream articulation axis 45′ and to the downstream articulation axis 46′.

Furthermore, generally speaking, the downstream end 422 of the terminal boom 42 is moved in space by the operating means 6 which are controlled by the control means 7.

In particular, the downstream end 422 is movable on the three axes (also called dimensions or directions), advantageously according to a position defined in a Cartesian coordinate system, namely advantageously:
the width (left/right) of the x-axis, or abscissa, horizontal,
the depth (front/back) of the y-axis, or ordinate, horizontal, and
the height (top/bottom) of the z axis, or vertical dimension.

For this purpose, the operating means 6 comprise:
at least one pivot actuator 61, for generating the pivoting movement of said articulated boom 4,
at least one first linear actuator 62 (also called “luffing cylinder”), for example a linear actuator or two parallel linear actuators, to generate the oscillating movement of the main boom 41 around its upstream articulation axis 45′ (lifting), and
at least one second linear actuator 63 (also called “folding cylinder”), for example a linear actuator or two parallel linear actuators, to generate the folding movement of the terminal boom 42 around its downstream articulation axis 46′.

The operating means 6 are adapted to operating the articulated boom 4 between a working position and a rest position.

Generally speaking, the working position advantageously corresponds to the state in which the articulated boom 4 is deployed and ready to carry out lifting operations.

Conversely, the rest position advantageously corresponds to the position of the crane 3 when it is not in use. The articulated boom 4 is folded or partially folded; the crane 3 is in particular ready to withstand bad weather in complete safety.

Preferably, in the working position, the control means 7 are designed to control the operating means 6 so as to stabilize (in space, advantageously along the three axes) the downstream end 422 of the terminal boom 42.

For this, the control means 7 advantageously comprise an active compensation module (also called “Active 3D Compensation”) which is designed to control the operating means 6, taking into account data coming from a movement acquisition module (also called “MRU” for “Motion Reference Unit”), so as to stabilize the downstream end 422 of the terminal boom 42.

The active compensation module is thus structured to control the operating means 6 so as to compensate for the movements of the crane 3, and in particular of the downstream end 422 of the terminal boom 42, caused by the waves.

Such an active compensation module thus provides precise positioning of the downstream end 422 of the terminal boom 42, making it possible to maintain this downstream end 422 of the terminal boom 42 in a constant position.

Preferably, the maneuver towards the rest position is ensured by the control means 7 which are designed to control the operating means 6 so as to position the downstream end 422 of the terminal boom 42 at the cradle 10.

In general, the crane 3 may optionally include locking means, for locking the crane 3 in its rest position (for example mechanical locking means at the joints and/or the operating means 6, in particular a set of pins).

### Cradle

According to the invention, the deck 2 is equipped with a cradle 10 which is located at a distance from the support structure 5.

This cradle 10 is designed to receive the head 422 of the terminal boom 42, when the articulated boom 4 is in the rest position.

Preferably, the deck 2 is equipped with a boom support consisting of this cradle 10, arranged at a distance from the support structure 5, without additional support for the main boom.

In other words, the boom support is made entirely in the form of the cradle 10, without including other support elements, in particular for the main boom.

In still other words, deck 2 lacks additional support for the main boom 41.

With no intermediate support under the main boom, the design allows for a significant reduction in deck space requirements, whilst ensuring effective support for the articulated boom in its folded configuration.

This architecture simplifies the structure of the unit and optimizes the space available on the deck, in particular by removing the constraints linked to the integration of a main boom support.

Additionally, it lightens the structural load applied to the deck, reducing the need for additional reinforcements.

By concentrating the boom support only at the terminal boom, the invention advantageously offers a more compact, lighter solution that is better suited to the operational constraints of offshore unit.

Preferably, as shown in FIG. 1, the cradle 10 is installed on the deck 2 so that, in the rest position, the terminal boom 42 has an angle N ranging from 0° to 10° relative to the vertical V.

This angle N advantageously corresponds to the angle formed between:
a longitudinal axis 42′ passing through the terminal boom 42, and
the vertical V, preferably oriented perpendicular to deck 2.

More preferably, in the rest position, the terminal boom 42 is divergent relative to the support structure 5, in the direction of the deck 2.

For this, as shown in FIGS. 4 and following, the cradle 10 comprises a receiving portion 101 on which the head 422 of the terminal boom 42 is intended to rest.

Preferably, the cradle 10, partially shown in FIG. 4, is secured to the deck 2 by means of an interface or a base.

According to a preferred embodiment, the cradle 10 consists of a column (or post or upright), erected on the deck 2.

This cradle 10 includes:
a lower end 102 secured to the deck 2, and
an upper end 103 comprising the receiving portion 101.

As mentioned above, the head 422 of the terminal boom 42 and the receiving portion 101 of the cradle 10 comprise complementary surfaces, for example cylindrical complementary surfaces, adapted to cooperate by interlocking.

In this case, the receiving portion 101 advantageously comprises two receiving strips 1011 which are intended to come on either side of the head 422 and each to receive one of the support members 4221.

The two receiving strips 1011 advantageously extend at a distance from each other and parallel to each other (advantageously symmetrical to each other).

The spacing between these two receiving strips 1011 is adapted for the passage of the head 422 of the terminal boom 42 in the rest position.

More preferably, each receiving strip 1011 comprises at least one inclined flap 1011a which ends, at a lower end 1011a1, with a notch 1011b intended to receive a support member 4221.

The notch 1011b here consists of a generally U-shaped notch (advantageously opening upwards), comprising two side walls 1011b1 (advantageously parallel) connected by a bottom wall 1011b2 in the shape of an arc of a circle (FIG. 5).

The distance between the side walls 1011b1 advantageously corresponds, to the clearance, to the diameter of one of the support members 4221. And the radius of the bottom wall 1011b2 advantageously corresponds, to the clearance, to the radius of the support member 4221.

The through axis 1011b′ of the notches 1011b (illustrated in FIG. 5) advantageously extends perpendicularly to the pivot axis 5′ of the articulated boom 4.

More preferably, each receiving strip 1011 comprises two inclined flaps 1011a, in a V shape, which meet at the notch 1011b, to guide the fitting of the support members 4221.

Preferably, a first inclined flap 1011a has a greater length than a second inclined flap 1011a, in order to serve as a guide ramp.

Said at least one inclined flap 1011a advantageously comprises a coating adapted to limit friction during the movement of the support members 4221 (for example a plastic sheet having a thickness ranging from 5 to 15 mm).

### Maneuvering Process

The crane 3 is thus intended to be maneuvered, during a maneuvering process, between the working position and the rest position.

When maneuvering from the working position to the rest position, the crane 3 is maneuvered so that the head 422 of the terminal boom 42 is maneuvered toward the cradle 10 until this head 422 rests on the receiving portion 101 (FIGS. 6 and 7).

In this case, preferably, the head 422 is maneuvered so that:
the support members 4221 come to rest on the inclined flaps 1011a, then
the support members 4221 travel along the length of the inclined flaps 1011a until they are housed in the respective notches 1011b.

In the rest position, the terminal boom 42 has an angle N ranging from 0° to 10° relative to the vertical V (FIG. 1).

In this resting position, the head 422 is mechanically locked with the cradle 10, ensuring optimum safety.

When maneuvering from the rest position to the working position, the crane 3 is maneuvered so that the head 422 of the terminal boom 42 is moved away from the cradle 10.

In this case, preferably, the head 422 is maneuvered so that the support members 4221 are extracted vertically relative to the respective notches 1011b.

Of course, various other modifications may be made to the invention within the scope of the appended claims.

1. Unit (1) for offshore application, comprising a deck (2) equipped with a crane (3) with an articulated boom (4),
which crane (3) comprises:
a support structure (5), secured to said deck (2), and
an articulated boom (4), carried by said support structure (5),
operating means (6), for operating said articulated boom (4) between a working position and a rest position, and
control means (7), for piloting said operating means (6),
which articulated boom (4) comprises a main boom (41) and a terminal boom (42), in series, which terminal boom (42) comprises a head (422) opposite said support structure (5),
characterized in that said deck (2) is equipped with a cradle (10), at a distance from the support structure (5), which comprises a receiving portion (101) on which the head (422) of said terminal boom (42) is intended to rest in said rest position.

2. Unit (1) for offshore application, according to claim 1, characterized in that the deck (2) is equipped with said cradle (10) and is devoid of an additional support for the main boom (41).

3. Unit (1) for offshore application, according to claim 1, characterized in that the cradle (10) is installed on the deck (2) so that, in the rest position, the terminal boom (42) has an angle N ranging from 0° to 10° relative to the vertical (V).

4. Unit (1) for offshore application, according to claim 1, characterized in that the cradle (10) consists of a column, erected on the deck (2), which comprises:
a lower end (102) secured to the deck (2), and
an upper end (103) comprising the receiving portion (101).

5. Unit (1) for offshore application, according to claim 1, characterized in that the head (422) of the terminal boom (42) and the receiving portion (101) comprise complementary surfaces, for example cylindrical complementary surfaces, adapted to cooperate by interlocking.

6. Unit (1) for offshore application, according to claim 1, characterized in that the head (422) of the terminal boom (42) comprises two support members (4221), on either side of said head (422),
and in that the receiving portion (101) comprises two receiving strips (1011) which are intended to come on either side of said head (422) and to each receive one of said support members (4221).

7. Unit (1) for offshore application, according to claim 6, characterized in that each receiving strip (1011) comprises at least one inclined flap (1011a) which ends, at a lower end (1011a1), by a notch (1011b) intended to receive said support member (4221).

8. Unit (1) for offshore application, according to claim 7, characterized in that said at least one inclined flap (1011a) comprises a coating suitable for limiting friction.

9. Unit (1) for offshore application, according to claim 1, characterized in that the crane (3) comprises locking means, for locking the crane (3) in its rest position.

10. Method of operating the crane (3) on a unit (1) according to according to claim 1, between said working position and said rest position,
characterized in that, when maneuvering it from the working position to the rest position, the crane (3) is maneuvered so that the head (422) of the terminal boom (42) is maneuvered towards the cradle (10) until it rests on the receiving portion (101).

11. Method of operating the crane (3) according to claim 10, characterized in that, in the rest position, the terminal boom (42) has an angle N ranging from 0° to 10° relative to the vertical (V).

12. Unit (1) for offshore application. according to claim 5. characterized in that the head (422) of the terminal boom (42) and the receiving portion (101) comprise cylindrical complementary surfaces, adapted to cooperate by interlocking.
